(19) United States
(12) Patent Application Publication
(10) Pub. No.: US 2004/0064804 A1
(43) Pub. Date: Apr. 1, 2004

(54) Generation of partitioned enterprise application using a high-level specification

(76) Inventors: Bruce K. Daniels, Capitola, CA (US); Robert N. Goldberg, Emerald Hills, CA (US); Yury Kamen, Foster City, CA (US); Syed M. Ali, Sunnyvale, CA (US)

Correspondence Address: ROSENTHAL & OSHA L.L.P. / SUN, 1221 MCKINNEY, SUITE 2800, HOUSTON, TX, 77010, US

(21) Appl. No.: 10/255,885

(22) Filed: Sep. 26, 2002

(51) Int. Cl. G06F 9/44

(52) U.S. Cl. 717/106

(57) ABSTRACT

A method for generating a partitioned enterprise application, including obtaining a business object specification defining a characteristic of a business object, obtaining an application usage specification defining how the business object is to be used in the partitioned enterprise application, obtaining partitioning information, and generating the partitioned enterprise application using the business object specification, the application usage specification, and the partitioning information.

### BACKGROUND OF INVENTION

Modern enterprise applications are typically implemented as multi-tier systems. Multi-tier systems serve an end-user through a chain of client/server pairs. In general, they include a user interface at the front end, a database management system (DBMS) at the back end, and an application server in between the user interface and the database. Depending on a particular component providing the user interface, an additional middle tier may exist between the user interface and the application server.

For example, if the user interface is provided by a web browser, a web server would exist between the web browser and the application server. The web browser would send requests to the web server, and the web server would interact with application data in the database through the application server in order to generate a response to send to the web browser. In this scenario, the web browser and web server form a client/server pair, the web server and application server form another client/server pair, and the application server and DBMS server form another client/server pair.

FIG. 1 shows an example of a four-tiered system that includes a user interface tier (2), a web server tier (4), an application server tier (6), and a data tier (8). The user interface tier (2) is a layer of interaction and typically includes a form-like Graphical User Interface (GUI) displayed by a display component, typically a web browser (10). The web server tier (4) includes web components (12) hosted on a web server (14). The web components (12) generate the content displayed by the web browser (10). The application server tier (6) includes application components (16) hosted on an application server (18). The application components (16) model standard business rules, typically through interaction with application data. The data tier (8) includes a persistent data store, typically a database management system (DBMS) (20) and a database (22).

The web browser (10) and the web server (14) form a client/server pair.

The web server (14) and the application server (18) form another client/server pair. The application server (18) and DBMS (20) form yet another client/server pair. A web component (12) and an application component (16) are in a client/server relationship when the web component (12) (client) uses services of the application component (16) (server) to provide functions to the system. In order for the client and server to collaborate, there is a contract, or interface definition, between the client and server that specifies server methods that can be invoked by the client. When the client and server are in different address spaces, the client may use a form of remote procedure call (RPC) to invoke the server methods. Typically, this involves the client calling into a local method or function (e.g., a stub), which forwards the call to the server.

Enterprise applications, such as described above, that execute on multiple tiers are difficult to write because they are inherently complex. Therefore, object-oriented programming techniques and constructs (i.e., classes, objects, methods, attributes, etc.) are often used to organize enterprise application functionality. For example, the enterprise application functionality may be organized into “business objects,” that are used to encapsulate business logic of the enterprise application, specific to the business for which the enterprise application is designed. For example, a business object may represent an everyday aspect of a business, such as a customer account, a purchase order, a student university record, etc.

Methods and attributes are typically associated with the business object, e.g., customer.sendInvoice( ), purchaseOrder.calculateTotal( ), student.GPA, etc. A single business object may have multiple methods. For example, in the purchase order example listed above, the purchase order may have a method for calculating the total amount of money the customer has spent in the last 24 hours, and a method that retrieves the customers order history. Those skilled in the art will appreciate that a business object may be represented by means other than object-oriented programming techniques.

In the interests of improved efficiency, improved performance, improved user experience, etc., business objects of an enterprise application may be distributed to particular tiers of a multi-tiered system. The decision of which tier to place the business object on typically includes determining the demands made by the enterprise application for the business object. Additionally, the runtime environment of the business object may also be considered. For example, a business object containing a method that performs complex, time-consuming numerical calculations may be placed on a middle tier (e.g., 4 in FIG. 1), where computing resources are likely to be more readily available for such calculations. Similarly, a business object containing a method that requires frequent queries of a database may be placed on a data tier (e.g., 22 in FIG. 1). However, a business object that includes both a method that performs complex and time-consuming numerical calculations and a method that requires frequent queries of a database, may be placed on the middle tier or on the data tier, depending upon the particular implementation needs of the multi-tier system.

### SUMMARY OF INVENTION

In general, in one aspect, the invention relates to a method for generating a partitioned enterprise application, comprising obtaining a business object specification defining a characteristic of a business object, obtaining an application usage specification defining how the business object is to be used in the partitioned enterprise application, obtaining partitioning information, and generating the partitioned enterprise application using the business object specification, the application usage specification, and the partitioning information.

In general, in one aspect, the invention relates to a computer system for generating a partitioned enterprise application, comprising a processor, a memory, a storage device, a computer display, and software instructions. The software instructions are stored in the memory for enabling the computer system under control of the processor, to perform: obtaining a business object specification defining a characteristic of a business object, obtaining an application usage specification defining how the business object is to be used in the partitioned enterprise application, obtaining partitioning information, and generating the partitioned enterprise application using the business object specification, the application usage specification, and the partitioning information.

In general, in one aspect, the invention relates to an apparatus for generating a partitioned enterprise application, comprising means for obtaining a business object specification defining a characteristic of a business object, means for obtaining an application usage specification defining how the business object is to be used in the partitioned enterprise application, means for obtaining partitioning information, and means for generating the partitioned enterprise application using the business object specification, the application usage specification, and the partitioning information.

Other aspects and advantages of the invention will be apparent from the following description and the appended claims.

### BRIEF DESCRIPTION OF DRAWINGS

FIG. 1 illustrates a typical multi-tier system.

FIG. 2 illustrates a typical computer.

FIG. 3 illustrates a flow diagram for generating a partitioned enterprise application, in accordance with an embodiment of the invention.

FIG. 4 illustrates a graphical representation of a business object specification, in accordance with an embodiment of the invention.

FIG. 5 illustrates a graphical representation of an application usage specification, in accordance with an embodiment of the invention.

FIG. 6 illustrates a method for generating a partitioned enterprise application, in accordance with an embodiment of the invention.

### DETAILED DESCRIPTION

Exemplary embodiments of the invention will be described with reference to the accompanying drawings. Like items in the drawings are shown with the same reference numbers.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The invention relates to a method for generating a partitioned enterprise application, i.e., an entire enterprise application or a portion of the application. Further, the invention relates to using a business object specification, partitioning information, and an application usage specification to generate the partitioned enterprise application.

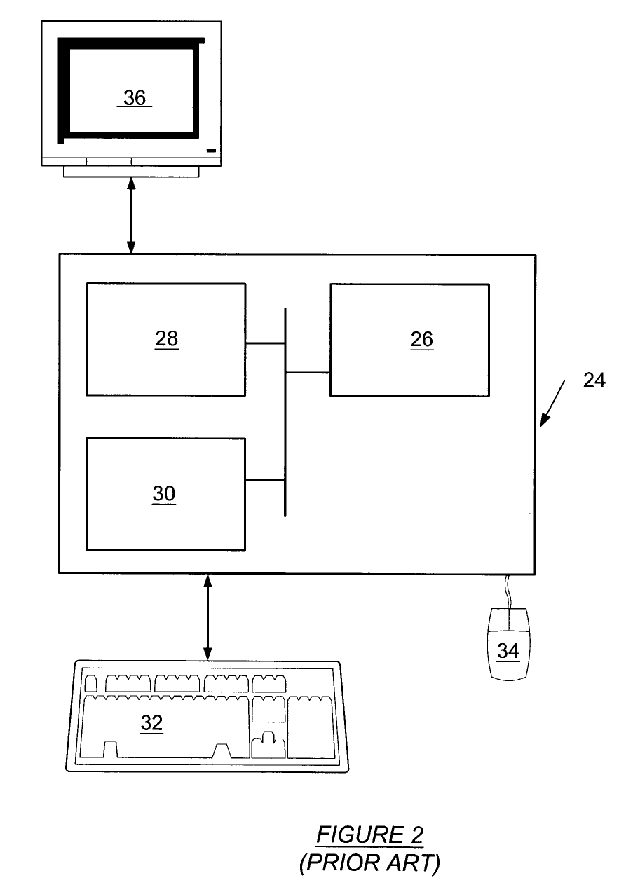

The invention may be implemented on virtually any type computer regardless of the platform being used. For example, as shown in FIG. 2, a typical computer (24) includes a processor (26), memory (28), a storage device (30), and numerous other elements and functionalities typical of today's computers (not shown). The computer (24) may also include input means, such as a keyboard (32) and a mouse (34), and output means, such as a monitor (36). Those skilled in the art will appreciate that these input and output means may take other forms in an accessible environment.

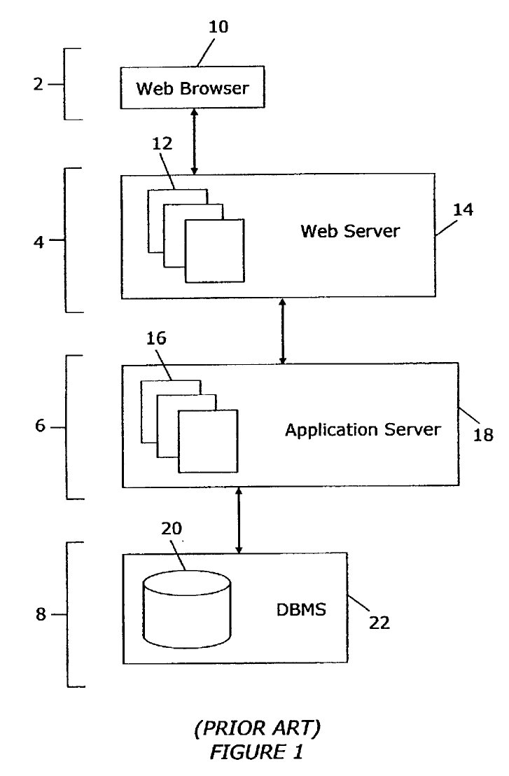

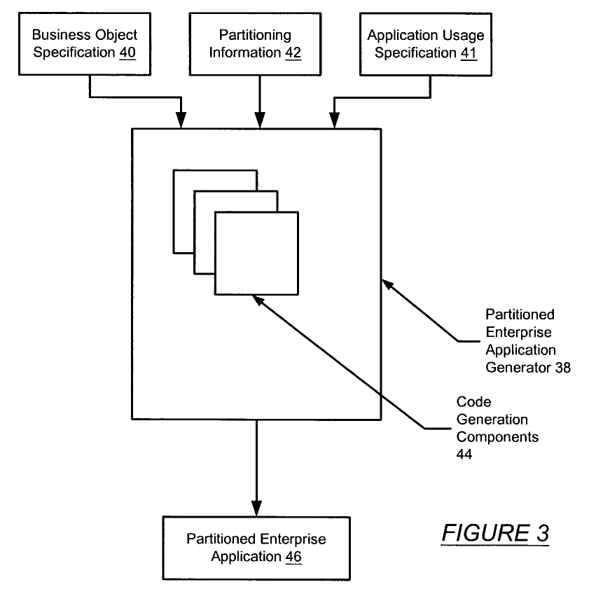

FIG. 3 illustrates a flow diagram for generating a partitioned enterprise application in accordance with one embodiment of the invention. The Partitioned Enterprise Application Generator (PEAG) (38) takes a Business Object Specification (BOS) (40), an Application Usage Specification (AUS) (41), and Partitioning Information (PI) (42) as inputs and generates a Partitioned Enterprise Application (PEA) (46). The PEA (46) is a partitioned enterprise application in which methods of the business objects are distributed across the multi-tier system in order to enhance performance, efficiency, user experience, etc., of the PEA (46). Furthermore, a BOS in the PEA (46) may include a first method and a second method. By partitioning such methods, the first method may be deployed on a first tier (e.g., the application server tier (6 in FIG. 1)), and the second method may be deployed on a second tier (e.g., the user interface tier, such as a web browser (10 in FIG. 1)). Alternatively, the methods of the PEA (46) may be partitioned across logical tiers, i.e., one physical server may host both a web server and a database server.

In an embodiment of the invention, the BOS (40) defines the characteristics of the business objects to be used in the PEA (46). These characteristics may include, but are not limited to, attributes, attribute constraints, persistence information, triggers, relationships, business object methods, etc. For example, the BOS (40) may define a trigger for a particular business object such that when a specific event occurs, such as an update to a data field in a database, a set of Structured Query Language (SQL) statements is “fired-off” to perform an integrity check on the database. Additionally, the business object methods may define enterprise application logic. Further, the BOS (40) defines the relationships between the various business objects.

The following code illustrates an exemplary BOS (40), in accordance with the embodiment described above.

Code Sample 1: Business Object Specification

| | |
|---|---|
| 1 | persistent class PurchaseOrder { |
| 2 | PROPERTIES { UUID = |
| | “ID_C0048140360711D6B3B30080C74455C6” }; |
| 3 | persistent Long orderId; |
| 4 | persistent Date orderDate = new Date(0); |
| 5 | persistent String shipToName; |
| 6 | persistent String shipToPhone; |
| 7 | persistent String shipToAddress1; |
| 8 | persistent String shipToAddress2; |
| 9 | persistent String shipToCity; |
| 10 | persistent String shipToState; |
| 11 | persistent String shipToZip; |
| 12 | persistent String shipToCountry = “USA”; |
| 13 | persistent String billToName; |
| 14 | persistent String billToPhone; |
| 15 | persistent String billToAddress1; |
| 16 | persistent String billToAddress2; |
| 17 | persistent String billToCity; |
| 18 | persistent String billToState; |
| 19 | persistent String billToZip; |
| 20 | persistent String billToCountry = “USA”; |
| 21 | computed Decimal orderTotal = |
| 22 | { |
| 23 | BigDecimal total = new BigDecimal(0); |
| 24 | Iterator i = getLineItems( ).iterator( ); |
| 25 | while(i.hasNext( )) { |
| 26 | LineItem li = (LineItem )i.next( ); |
| 27 | total = total.add(li.getLineTotal( )); |
| 28 | } |
| 29 | return total; |
| 30 | } owns (0,n,1,1) LineItem lineItems orderId; |
| 31 | |
| 32 | PRIMARY KEY (orderId); |
| 33 | |
| 34 | factory method myOrders (String billToName) returns List of |
| 35 | PurchaseOrder |
| 36 | |
| 37 | QUERY ( SELECT p |
| 38 | FROM PurchaseOrder p |
| 39 | WHERE billToName = :billToName ) |
| 40 | |
| 41 | factory method nextId( ) returns Long |
| 42 | |
| 43 | QUERY ( SELECT MAX(p.orderId) + 1 |
| 44 | FROM PurchaseOrder p ) |
| 45 | |
| 46 | |
| 47 | factory method assignNextPK( ) returns PurchaseOrderPK |
| 48 | |
| 49 | { |
| 50 | synchronized (this.getClass( )) { |
| 51 | PurchaseOrderFactory f = (PurchaseOrderFactory |
| 52 | )Global.factoryManager( ). |
| | getFactory(PurchaseOrder .class); |
| 53 | PurchaseOrderPK pk; |
| 54 | pk = f.newPrimaryKey(nextId( ).longValue( )); |
| 55 | return pk; |
| 56 | } |
| 57 | } |
| 58 | |
| 59 | } // class PurchaseOrder |
| 60 | |
| 61 | persistent class LineItem { |
| 62 | |
| 63 | PROPERTIES { UUID = |
| | “ID_C00A9BC0360711D6B3B30080C74455C6” }; |
| 64 | |
| 65 | persistent Long orderLine; |
| 66 | persistent String productId; |
| 67 | persistent String productName; |
| 68 | persistent String productDescription; |
| 69 | persistent Decimal unitPrice; |
| 70 | persistent Long quantity; |
| 71 | computed Decimal lineTotal = ((this.getUnitPrice( ).multiply( |
| 72 | new BigDecimal(String.valueOf(this.getQuantity( )))))); |
| 73 | |
| 74 | PRIMARY KEY (orderId, orderLine); |
| 75 | |
| 76 | |
| 77 | factory method nextLineNumber(Long orderId) returns Long |
| 78 | |
| 79 | QUERY ( SELECT MAX(li.orderLine) + 1 |
| 80 | FROM LineItem li |
| 81 | WHERE li.orderId = :orderId ) |
| 82 | |
| 83 | |
| 84 | factory method assignNextPK(PurchaseOrder master) |
| | returns LineItemPK |
| 85 | |
| 86 | { |
| 87 | synchronized (this.getClass( )) { |
| 88 | LineItemFactory f = (LineItemFactory) |
| 89 | Global.factoryManager( ).getFactory(LineItem .class); |
| 90 | LineItemPK pk = f.newPrimaryKey(master, |
| 91 | f.nextLineNumber(master.getOrderId( )).longValue( )); |
| 92 | return pk; |
| 93 | } |
| 94 | } |
| 95 | |
| 96 | } // class LineItem |

In the code sample listed above, referred to as “Code Sample 1”, lines 1-59 define a PurchaseOrder business object. Specifically, within the PurchaseOrder business object, lines 3-29 define attributes of the PurchaseOrder business object. Line 30 defines a relationship between the PurchaseOrder business object and a LineItem business object; in particular, the PurchaseOrder business object “owns” the LineItem business object. Line 32 defines the primary key of the PurchaseOrder business object. Lines 34-59 define methods for the PurchaseOrder object. Lines 61-96 define the LineItem business object.

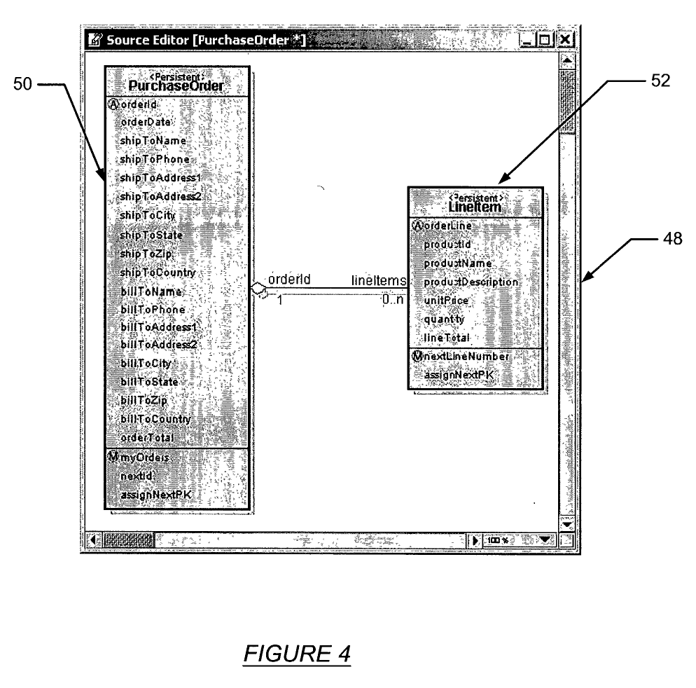

FIG. 4 illustrates a graphical representation of a business object specification in accordance with an embodiment of the invention. The graphical representation of the BOS (48) corresponds to “Code Sample 1” listed above. The BOS (48) includes two business objects: PurchaseOrder (50), and LineItem (52). Further, the BOS (48) graphically illustrates the “own” relationship. In addition, each business object (i.e., PurchaseOrder (50) and LineItem (52)) within the BOS (48) include all attributes and methods defined in “Code Sample 1.” In an embodiment of the invention, an integrated development environment (IDE), such as Forte™ for Java™, is used to graphically define the business object specification.

Returning to FIG. 3, the AUS (41) defines how the business objects, as defined by the BOS (40), are to be used within the PEA (46). In one embodiment of the invention, the AUS (41) is defined as a series of states and transitions. A state defines an interaction with a client (i.e., a user, another PEA, a web service, etc.). The interaction may include, but is not limited to, a user gesture (e.g., a button click, voice commands, etc.), an interaction from another PEA (e.g., via a web service using Simple Object Access Protocol (SOAP)), etc. Those skilled in the art will appreciate that an interaction may take on other forms in an accessible environment.

In a web-based application, for example, a user may be presented with a screen on a web page that requires the user to enter a number corresponding to the number of items they wish to purchase and then click a “proceed” button. In this case, that particular web page would represent the state. Further, a state may contain an embedded state. The embedded state corresponds to a state residing in a state. For example, in a web page, a state may correspond to the entire web page and the embedded state may correspond to a frame within the web page. Additionally, a state may also contain a conditional state. For example, a conditional state may display the current date and time to the user. Thus, the state is conditional on the current time and date.

The transitions correspond to business logic of the PEA (46). Continuing with the web page example above, when the user clicks the “proceed” button, the transition is initiated. In this particular case, the transition may include code to determine a total price of the products being ordered using a number of items that the user previously entered.

The transitions are used to link the various states together forming an overall business process. Further, a particular PEA may be defined such that numerous transitions may be used to exit a particular state. For example, in a web-based application, a particular screen may have a “proceed” button and an “exit” button, where each button triggers a different set of business logic. Further, numerous transitions may also be used to enter a particular state. For example, a “proceed” button on one page and a “cancel” button on another page could both result in bringing the user back to the PEA's (46) homepage.

Additionally, the AUS (41) may also define interaction variables. An interaction variable defines a piece of data which is going to interact with the user, or to facilitate interactions within the PEA (46) or with the end user, e.g., parameters passed between states, shared variables, session variables, state variables, etc.

The following code illustrates an exemplary AUS, in accordance with the embodiment described above.

Code Sample 2: Application Usage Specification

| | |
|---|---|
| 1 | package com.sun.purchaseorder; |
| 2 | |
| 3 | bos POApplication = com.sun.purchaseorder; |
| 4 | |
| 5 | session String customerName; |
| 6 | |
| 7 | initial state { |
| 8 | |
| 9 | { customerName = “”; |
| 10 | } |
| 11 | |
| 12 | customerName: C ; |
| 13 | |
| 14 | transition Start { |
| 15 | switch (customerName) { |
| 16 | case “”: return new initial( ); |
| 17 | default: return new ChoosePO( ); |
| 18 | } |
| 19 | |
| 20 | } // transition Start |
| 21 | |
| 22 | } // state initial |
| 23 | |
| 24 | state ChoosePO( ) |
| 25 | { |
| 26 | local List of PurchaseOrder purchaseOrders; |
| 27 | |
| 28 | { purchaseOrders = |
| 29 | factory(POApplication.PurchaseOrder).myOrders(customerName); |
| 30 | } |
| 31 | |
| 32 | [purchaseOrders(0,n)]: R { |
| 33 | orderId “Order ID” |
| 34 | } |
| 35 | |
| 36 | transition CreatePO “Create Purchase Order” { |
| 37 | return new CreatePO( ); |
| 38 | |
| 39 | } // transition CreatePO |
| 40 | |
| 41 | transition DeletePO “Delete Purchase Order” { |
| 42 | PurchaseOrder po = purchaseOrders.getSelectedOne( ); |
| 43 | factory(POApplication.PurchaseOrder).remove(po); |
| 44 | return new ChoosePO( ); |
| 45 | |
| 46 | } // transition DeletePO |
| 47 | |
| 48 | transition EditPO “Edit Purchase Order” { |
| 49 | PurchaseOrder po = purchaseOrders.getSelectedOne( ); |
| 50 | return new EditPO(po); |
| 51 | |
| 52 | } // transition EditPO |
| 53 | |
| 54 | } // state ChoosePO |
| 55 | |
| 56 | state CreatePO( ) |
| 57 | { |
| 58 | |
| 59 | |
| 60 | # =“ This state transfers directly to EditPO since it has no |
| 61 | usage and one transition ” |
| 62 | transition CreateAndEditPO { |
| 63 | PurchaseOrderPK pk = |
| 64 | factory(POApplication.PurchaseOrder).assignNextPK( ); |
| 65 | PurchaseOrder po = |
| | factory(POApplication.PurchaseOrder).create(pk); |
| 66 | po.setBillToName(customerName); |
| 67 | return new EditPO(po); |
| 68 | |
| 69 | } // transition CreateAndEditPO |
| 70 | |
| 71 | } // state CreatePO |
| 72 | |
| 73 | state EditPO( PurchaseOrder po) “Edit Purchase Order” |
| 74 | { |
| 75 | |
| 76 | po: RW { |
| 77 | orderId “Order ID”: R, |
| 78 | orderDate “Date”, |
| 79 | shipToName “Ship To”, |
| 80 | shipToPhone “Phone”, |
| 81 | shipToAddress1 “Address”, |
| 82 | shipToAddress2 “Address2”, |
| 83 | shipToCity “City”, |
| 84 | shipToState “State”, |
| 85 | shipToZip “Zip Code”, |
| 86 | shipToCountry “Country”, |
| 87 | billToName “Bill To”, |
| 88 | billToPhone “Phone”, |
| 89 | billToAddress1 “Address”, |
| 90 | billToAddress2 “Address2”, |
| 91 | billToCity “City”, |
| 92 | billToState “State”, |
| 93 | billToZip “Zip Code”, |
| 94 | billToCountry “Country”, |
| 95 | [lineItems(0,n)] “Line Items” { |
| 96 | orderLine “Item”, |
| 97 | productId “Product ID”, |
| 98 | productName “Product”, |
| 99 | productDescription “Description”, |
| 100 | unitPrice “Unit Price”, |
| 101 | quantity “Quantity” |
| 102 | } |
| 103 | } |
| 104 | |
| 105 | transition Update { |
| 106 | return new EditPO(po); |
| 107 | |
| 108 | } // transition Update |
| 109 | |
| 110 | transition AddLineItem “Add Line Item” { |
| 111 | LineItemPK pk = |
| | factory(POApplication.LineItem).assignNextPK(po); |
| 112 | LineItem li = factory(POApplication.LineItem).create(pk); |
| 113 | return new EditPO(po); |
| 114 | |
| 115 | } // transition AddLineItem |
| 116 | |
| 117 | transition DeleteLineItem “Delete Line Item” { |
| 118 | LineItem li = po.lineItems.getSelectedOne( ); |
| 119 | factory(POApplication.LineItem).remove(li); |
| 120 | return new EditPO(po); |
| 121 | |
| 122 | } // transition DeleteLineItem |
| 123 | |
| 124 | transition Done “Done Editing Purchase Order” { |
| 125 | return new ChoosePO( ); |
| 126 | |
| 127 | } // transition Done |
| 128 | |
| 129 | transition Discard “Discard Edits” { |
| 130 | return new DiscardEdits( ); |
| 131 | |
| 132 | } // transition Discard |
| 133 | |
| 134 | } // state EditPO |
| 135 | |
| 136 | state DiscardEdits( ) |
| 137 | { |
| 138 | local String message; |
| 139 | |
| 140 | { message = “Edits discarded”; |
| 141 | } |
| 142 | |
| 143 | message: R; |
| 144 | |
| 145 | transition Continue { |
| 146 | return new ChoosePO( ); |
| 147 | |
| 148 | } // transition Continue |
| 149 | |
| 150 | } // state DiscardEdits |

In the code sample listed above referred to as “Code Sample 2”, each state with the corresponding transitions are defined. Lines 7-22 define an Initial State and the necessary information for a Start transition. Similarly, lines 24-54 define the ChoosePO state and corresponding transitions, lines 56-71 define a CreatePO state and corresponding transition, lines 73-134 define a EditPO State and corresponding transitions, and lines 136-150 define a DiscardEdits State and corresponding transitions.

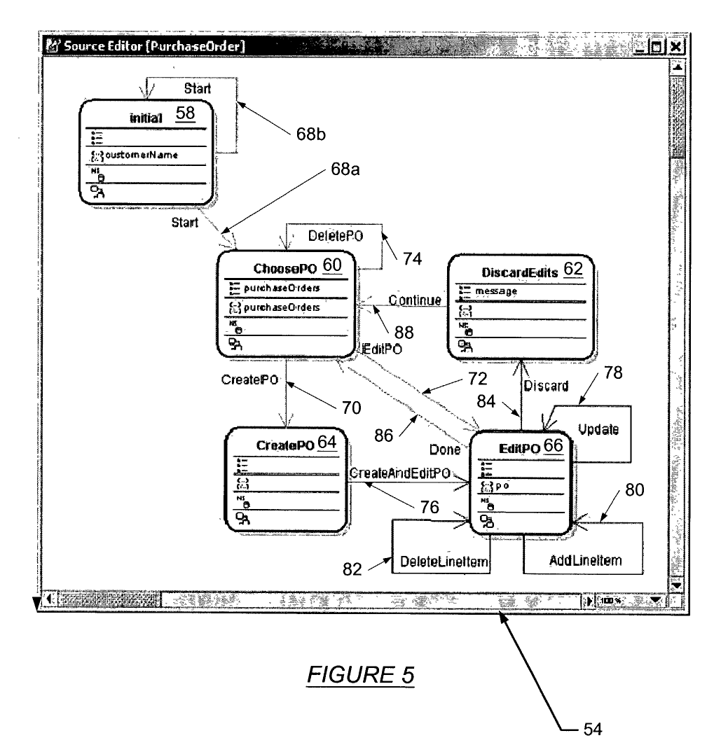

FIG. 5 illustrates a graphical representation of an application usage specification in accordance with one embodiment of the invention. The graphical representation of the AUS (54) corresponds to “Code Sample 2” listed above. The AUS (54) uses the BOS (48 in FIG. 4) described above. The AUS (54) includes five states: Initial (58), ChoosePO (60), DiscardEdits (62), CreatePO (64), and EditPO (66). Linking each state is a series of transitions.

For example, the Initial (58) state includes one transition: Start (68a, 68b).

The Start (68a, 68b) transition branches depending on conditions specified in source code (refer to lines 14-17 in Code Sample 2). Thus, the Start (68a, 68b) transition may transition the PEA to the ChoosePO (60) state via 68a, or return the PEA to the Initial (58) state via 68b. From the ChoosePO (60) state, the PEA can transition to the CreatePO (64) state via a CreatePO (70) transition; the PEA can transition to the EditPO (66) state via a EditPO (72) transition; or transition back to ChoosePO (60) state via a DeletePO (74) transition. From the CreatePO (64) state, the PEA can transition to the EditPO (66) state via a CreateAndEditPO (76) transition.

The EditPO (66) state includes five transitions: an Update (78) transition, a AddLineltem (80) transition, a DeleteLineItem (82) transition, a Discard (84) transition, and a Done (86) transition. The Update (78) transition, the AddLineltem (80) transition, and the DeleteLineItem (82) transition all return the PEA back to the EditPO (66) state. The Discard (84) transition places the PEA in the DiscardEdits (62) state. The Done (86) transition places the PEA in the ChoosePO (60) state. From the DiscardEdit (62) state, the PEA can transition to the ChoosePO (60) state via a Continue (88) transition. In one embodiment of the invention, an integrated development environment (IDE), such as Forte™ for Java™, is used to graphically define the application usage specification.

Returning to FIG. 3, in an embodiment of the invention, the PI (42) includes information used to determine where in the multi-tier system to place the method, i.e., on which tier to place the method. In accordance with an embodiment of the invention, the PI (42) includes information explicitly stating where a particular method is placed, as well as code optimization procedures or static code analysis used to determine where to place a given method. For example, a user may mandate where the method is placed. In this case, the user may specify that certain methods or methods with certain characteristics be placed in certain tiers. The user may use a GUI, a command line interface, etc., or other input means, to input such information.

Code optimization procedures, such as method placement procedures, may be stored in the PI (42). A first example of a method placement procedure is a rule that mandates that a method using an SQL query statement is placed in the data tier (8 in FIG. 1). A second example of a method placement procedure is a rule that mandates that a method using a user interface (e.g., a GUI) Application Programming Interface (API) be placed on a web server tier (4 in FIG. 1) or a user interface tier (e.g., a web browser (10 in FIG. 1)). A third example of a method placement procedure is a rule that mandates placing a method on a middle tier if the method has a nested loop requiring additional computational resources. Furthermore, heuristics may be used to analyze the BOS (40) and/or the AUS (41). Code optimization procedures stored in the PI (42) may also be used to analyze source code and compiled source code of the PEA (46).

In an embodiment of the invention, while partitioning a particular method onto a tier (physical or logical), control and data flow dependencies of the method should be considered. For example, method A may need to invoke method B. Thus, the benefit of partitioning method A to a particular tier is reduced if method B is not partitioned onto the same tier, i.e., control dependency. Similarly, the same sort of inefficiency may occur if method A changes data used by method B, or if method A depends on data that is not present on the tier, i.e., data dependency.

Information regarding capabilities of a runtime environment of the PEA (46) may also be included in the PI (42). For example, an amount of memory available on each tier, or the amount of bandwidth available for communication, etc., may be included in the PI (42). Other types of information included in the PI (42) may include information obtained from the BOS (40) and the AUS (41), such as an estimate of execution time for methods of business objects, and an estimate of an amount of data and/or bandwidth required for methods of the business objects.

Referring back to FIG. 3, the PEAG (38) includes a number of code generation components (CGC) (44). The CGC (44) correspond to generator components designed specifically for a particular platform. For example, if the PEA (46) is deployed on an Apache Web Server, an iPlanet™ Application server, and Oracle® Database Management System, the PEAG (38) contains CGC (44) corresponding to the Apache Web Server, the iPlanet™ Application server, and the Oracle® Database Management System. (iPlanet™ is a trademark of Sun Microsystems, and Oracle® is a registered trademark of the Oracle Corporation).

Further, the CGC (44) may encapsulate best-mode practices to produce optimized efficient code for the various components in the PEA (46). For example, the PEAG (38) may include functionality to increase performance efficiency of the PEA (46) by optimizing PEA implementation code. This optimization may include, but is not limited to, the use and generation of optimal distribution protocols to ensure maximal network access and response time within a given platform for high PEA (46) performance and scalability, optimization for lock contention, optimization for memory usage, optimization for processor usage, optimization for code readability, etc. In the event that the usage or execution environment changes, the PEA (46) may be re-generated using the same AUS (41), the BOS (40), and the PI (42), provided that the appropriate CGC (44) are present in the PEAG (38).

Further, in an embodiment of the invention, the PEAG (38) also includes functionality to determine the most efficient platform for deployment based on the AUS (41), BOS (40), and the PI (42) inputs into the PEAG (38).

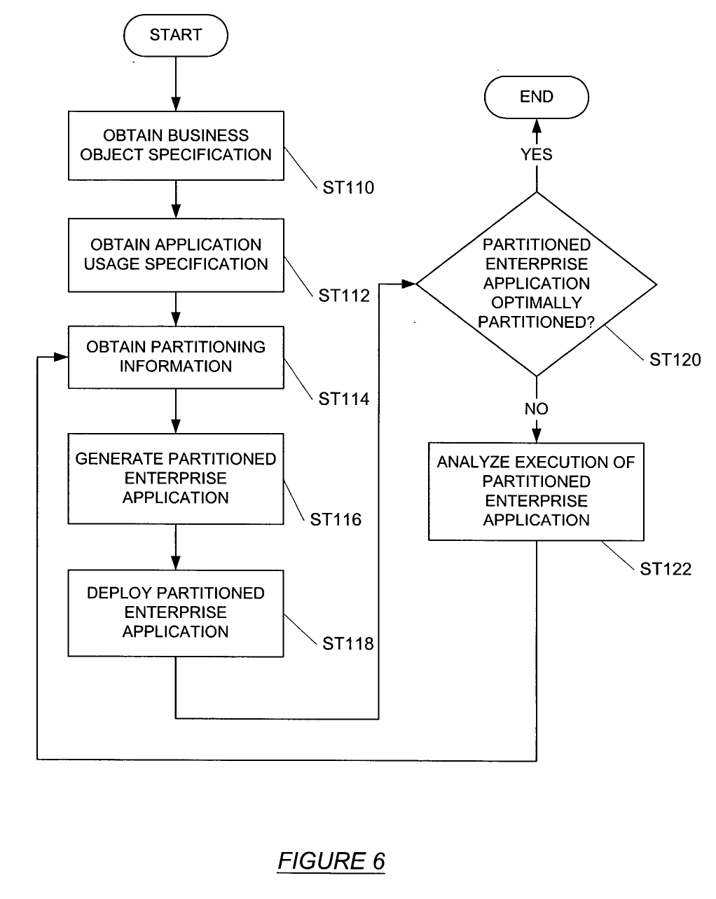

FIG. 6 illustrates a method for generating a partitioned enterprise application, in accordance with an embodiment of the invention. Initially, the BOS is obtained (Step 110). The BOS may include source code as previously shown in Code Sample 1. The AUS is subsequently obtained (Step 112). The AUS may include source code as shown in Code Sample 2 previously.

The PI is then obtained (Step 114). The PI may be obtained via multiple techniques. For example, system operational information (e.g., a statistical analysis of an amount of available memory for each tier on which the PEA is to be deployed) may be gathered for inclusion in the PI. Also, code optimization procedures (such as method placement procedures), may be obtained from the user or from a default file. Additionally, information may be obtained from the user (e.g., the user may estimate execution time and processor usage per method). In accordance with an embodiment of the invention, user input may be included as part of the AUS and/or BOS.

Once the BOS (40), AUS (42), and the PI (42) are obtained, the PEA is generated (Step 116). In accordance with an embodiment of the invention, the PEA is generated using the BOS, the AUS, and the PI, and is generated in multiple stages. For example, an initial implementation of the PEA, such as a default PEA, may be generated from the BOS, the AUS and other information stored in the PI (such as what type of programming language is required for a particular runtime environment or tier). The default PEA, once generated, may be analyzed and improved via application of code optimization procedures.

Analysis of source code and compiled source code of the default PEA is accomplished during Step 116. For example, source code of the default PEA may be analyzed (e.g., a number of loops counted, etc.), and code optimization procedures may be applied to a result of such analysis. Application of the code optimization procedures enables generation of additional source code or replacement source code (e.g., source code for additional code to handle platform discrepancies, etc.), thus generating updated PEA source code. Then, the updated PEA source code is compiled and analyzed (e.g., size in bytes of each method may be measured), and code optimization procedures may be applied to a result of such analysis. Application of the code optimization procedures enables additional source code to be generated (or regenerated). Recompilation of source code may also be required.

Those skilled in the art will appreciate that stages of generating the PEA as presented above may differ according to one or more embodiments of the invention. For example, analysis of source code or compiled source code, and generation of additional source code after application of code optimization procedures may not be performed, and the default PEA may be used as the PEA.

In accordance with an embodiment of the invention, the PEA may include additional instructions to specify a particular tier or tiers from which methods may be invoked and executed. For example, the PEA may include instructions (via compiled source code) to mandate that a method be placed on the application server tier and invoked only from the web server tier, and when invoked, the method is executed on the application server tier. Additionally, a method may be placed on multiple tiers, for purposes of redundancy.

In accordance with an embodiment of the invention, the PEA may include information to indicate where each method is placed so that each method may be located when necessary. Also, the PEA may include instructions to record modifications of data by methods of the PEA, so that when data is modified, any remote methods that may use such modified data are cannot be invoked until the modified data has been transmitted. Thus, provision is made for refreshing cached data before any relevant method is invoked which may use the cached data.

Returning to FIG. 6, once the PEA is generated, the PEA is deployed on the multi-tier system (Step 118). For example, referring back to code sample 1, line 71-72, a computed attribute (a type of method) lineTotal is defined as part of the LineItem object. In accordance with an embodiment of the invention, the PEA partitions the lineTotal method to reside in the browser, so that changes to the quantity or price of a given LineItem in the browser does not require a remote method call to calculate the updated total.

Once deployed, a determination is made as to whether the PEA is optimally partitioned (Step 120). In order to determine whether the PEA is optimally partitioned, multiple prior art techniques may be used, e.g. a bandwidth monitor.

Because FIG. 6 illustrates a potentially iterative method, techniques such as statistical analysis of successive iterations of the PEA may be used. A diminishing improvement of performance over successive iterations may be used to determine whether the PEA is optimally partitioned.

In accordance with an embodiment of the invention, information in the PI is accessed to determine whether the PEA is optimally partitioned. If the PEA is determined to be optimally partitioned, the method shown in FIG. 6 ends. Otherwise, performance of the PEA (once deployed) is analyzed, which may involve quantification of execution times and performances. For example, each method may be invoked and method execution time measured. A result of such analysis is stored in the PI. Step 114 through Step 120 are performed until the PEA is determined to be optimally partitioned. Those skilled in the art will appreciate that use of the word “optimally” above does not necessarily imply that further improvements of partitioning are impossible, but that “optimally” represents an improvement of at least a defined standard of partitioning, and may vary among implementations of the invention.

Those skilled in the art will appreciate that when implementing one or more embodiments of the invention, static analysis of the source code may be conducted prior to partitioning the enterprise application to determine associated methods and potential dependencies of particular methods upon one another. Additionally, the static analysis may be used to ascertain if a particular method is a closed method, i.e., the method does not require results from other methods, or the particular method is an open method. This information may be used to determine how to partition a method or group of related methods. Additionally, the static analysis may be used to derive modifications to the BOS and/or AUS, such as determining that a method that depends on an attribute not present on a tier may be partitioned if the AUS is modified to include the additional attribute. Further, in one or more embodiments of the invention, a consistency checker may be used to ensure that the partitioned code maintains its integrity and that the previously described side-effects do not occur, or at least are minimized.

Those skilled in the art will also appreciate that while the above discussion focused on the partitioning of methods, the present invention may be extended to partitioning of other implementation artifacts. For example, one may use the present invention to partition a parameter and/or a variable constraint or trigger on various tiers. For example, a constraint that requires a positive integer value between 1 and 3 for a particular field may be partitioned to execute on the web client.

Advantages of embodiments of the invention may include one or more of the following. A platform independent specification, i.e., the AUS and the BOS, is used to describe a PEA, thereby decreasing the knowledge barrier of a programmer to create a PEA and decreasing time to develop prototypes and facilitate feed-back. Further, using a platform independent specification allows the PEA to be easily distributed to existing platforms, and platforms yet to be developed. Further, the performance efficiency for the PEA is increased by generation of optimal distribution protocols. Furthermore, a concise code specification is produced, which allows rapid PEA development. Additionally, the intuitive nature of the code specification allows people other than programmers to participate in the application development process. Additionally, the robustness of the PEA is increased as a majority of code generated by the code.

By partitioning business objects of the PEA, performance efficiency of the PEA is enhanced. For example, a business object may include a first method that makes substantial database queries, and a second method to verify data type, data magnitude, etc., of data entered into GUI fields of a web browser by a user. If the business object is not partitioned, then both the first method and second method are placed on the same tier. Therefore, more time and bandwidth are required either for the database queries (if the business object is placed on the user interface tier), or the data verification of user-entered data (if the business object is placed on the data tier), or both (if the business object is placed on a middle tier). However, if the business object is partitioned, with the first method placed on the data tier, and the second method placed on the user interface tier (e.g., the web browser), then bandwidth use is enhanced, and the user experience is enhanced (no roundtrip for data verification), thus enhancing performance and efficiency. Furthermore, the invention allows an enterprise application to be optimized such that there is a limited number of round trips.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating a partitioned enterprise application, comprising:
obtaining a business object specification defining a characteristic of a business object;
obtaining an application usage specification defining how the business object is to be used in the partitioned enterprise application;
obtaining partitioning information; and
generating the partitioned enterprise application using the business object specification, the application usage specification, and the partitioning information.

2. The method of claim 1, wherein the business object comprises at least one implementation artifact.

3. The method of claim 2, wherein the at least one implementation artifact comprises a method.

4. The method of claim 2, wherein the at least one implementation artifact comprises a constraint.

5. The method of claim 2, wherein the at least one implementation artifact comprises a trigger.

6. The method of claim 2, wherein the partitioning information comprises an estimate of execution time for the at least one implementation artifact.

7. The method of claim 2, wherein the partitioning information comprises an amount of data required to be fetched for the at least one implementation artifact.

8. The method of claim 2, wherein the partitioning information comprises a compiled size of the at least one implementation artifact.

9. The method of claim 1, further comprising:
deploying the partitioned enterprise application to generate a deployed partitioned enterprise application;
executing the deployed partitioned enterprise application to obtain performance information; and
generating an optimized enterprise application using the application usage specification, the business object specification, the partitioning information, and the performance information.

10. The method of claim 9, further comprising:
applying a code optimization procedure to the performance information, wherein
the code optimization procedure is defined in the partitioning information.

11. The method of claim 1, wherein the partitioning information comprises an explicit user directive.

12. The method of claim 1, wherein the partitioning information is determined using static analysis.

13. The method of claim 12, further comprising:
modifying the application usage specification based on the static analysis.

14. The method of claim 1, wherein the partitioning information comprises runtime environment information for the partitioned enterprise application.

15. The method of claim 1, wherein generating the partitioned enterprise application comprises:
generating source code using the application usage specification, the business object specification, and the partitioning information;
analyzing the source code to generate an analysis result; and
generating an optimized source code by applying a code optimization procedure to the source code using the analysis result.

16. The method of claim 15, wherein the code optimization procedure involves advising an improvement to the optimized source code based on the analysis result.

17. The method of claim 15, wherein analyzing the source code comprises determining a number of source code loops for at least one implementation artifact.

18. The method of claim 15, wherein analyzing the source code comprises determining a number of source code statements for at least one implementation artifact.

19. The method of claim 15, wherein analyzing source code comprises using static analysis to determine if a dependency exists in the source code.

20. The method of claim 1, wherein generating the partitioned enterprise application uses a code generator, wherein the code generator comprises a plurality of code generation components specific to a plurality of platform components.

21. The method of claim 1, wherein the application usage specification is platform independent.

22. A computer system for generating a second partitioned enterprise application, comprising:
a processor;
a memory;
a storage device;
a computer display; and
software instructions stored in the memory for enabling the computer system under control of the processor, to perform:
obtaining a business object specification defining a characteristic of a business object;
obtaining an application usage specification defining how the business object is to be used in the partitioned enterprise application;
obtaining partitioning information; and
generating the partitioned enterprise application using the business object specification, the application usage specification, and the partitioning information.

23. The computer system of claim 22, wherein the business object specification is platform independent.

24. The computer system of claim 22, wherein the business object comprises at least one implementation artifact.

25. The computer system of claim 22, further comprising software instructions to perform:
deploying the partitioned enterprise application to generate a deployed partitioned enterprise application;
executing the deployed partitioned enterprise application to obtain performance information; and
generating an optimized enterprise application using the application usage specification, the business object specification, the partitioning information, and the performance information.

26. The computer system of claim 22, wherein generating the partitioned enterprise application comprises:
generating source code using the application usage specification, the business object specification, and the partitioning information;
analyzing the source code to generate an analysis result; and
generating an optimized source code by applying a code optimization procedure to the source code using the analysis result.

27. An apparatus for generating a partitioned enterprise application, comprising:
means for obtaining a business object specification defining a characteristic of a business object;
means for obtaining an application usage specification defining how the business object is to be used in the partitioned enterprise application;
means for obtaining partitioning information; and
means for generating the partitioned enterprise application using the business object specification, the application usage specification, and the partitioning information.

28. The apparatus of claim 27, further comprising:
means for deploying the partitioned enterprise application to generate a deployed partitioned enterprise application;
means for executing the deployed partitioned enterprise application to obtain performance information; and
means for generating an optimized enterprise application using the application usage specification, the business object specification, the partitioning information, and the performance information.

29. The apparatus of claim 27, wherein generating the partitioned enterprise application comprises:
means for generating source code using the application usage specification, the business object specification, and the partitioning information;
means for analyzing the source code to generate an analysis result; and
means for generating an optimized source code by applying a code optimization procedure to the source code using the analysis result.
